(19) United States
(12) Patent Application Publication
(10) Pub. No.: US 2019/0013675 A9
(43) Pub. Date: Jan. 10, 2019

(54) Combined renewable energy and compressed gas energy storage and generator microgrid system using reciprocating piezoelectric generators

(71) Applicant: Vamell M. Castor, Chelsea, MA (US)

(72) Inventor: Vamell M. Castor, Chelsea, MA (US)

(21) Appl. No.: 15/330,435

(22) Filed: Sep. 21, 2016

Related U.S. Application Data
(63) Continuation-in-part of application No. 14/645,013, filed on Mar. 11, 2015, now abandoned.
(60) Provisional application No. 61/950,889, filed on Mar. 11, 2014.

(51) Int. Cl. H02J 3/38; H02J 7/00

(52) U.S. Cl. CPC H02J 3/38; H02J 7/0068

(57) ABSTRACT

A combined heat and power system, namely a portable combined heat and power microgrid system with the capacity to convert air to electricity, since the system imparts excess energy derived from multiple electrical energy sources, namely renewables or other sources of electrical supply like gas-induced electrical generation, to produce and store energy as compressed heat that is then redirected to generate reciprocating energy utilizing a barrel housing or setting to promote direct kinetic energy transfer method onto an array of rowed piezoelectric generators that use sequential direct kinetic energy transference to produce electricity and store it in a second electrical storage unit that can be interconnected to the operational electrical storage unit to not only promote redirect electrical flow during peak or off-peak to extend systemic operations but also to promote high volumes of energy from multiple energy sources for electric user purposes, enabling communication with high density energy when stored.

### RELATED APPLICATION

This application is a continuation-in-part application of U.S. Non-Provisional patent application Ser. No. 14/645,013, filed Mar. 11, 2015, the contents of which are hereby incorporated by reference.

### FIELD OF THE INVENTION

The present invention relates to the field of energy production, conservation, and transference as a combined heat and power system; specifically, a portable isothermal compressed gas energy storage and generator system is proposed that works in conjunction with a plural of reciprocating novel generators and renewable energy input sources to produce excess energies during peak hours to alleviate intermittency periods and store not only high density of electrical energy but also high ratio of gas as compressed heat can be transferred from gas storage to generators to electrical storage for electric user to access during peak or off-peak periods to alleviate energy storage issues and conserve energy for longer periods.

This design incorporates a centered double-sided, dual-acting pneumatic piston drive to simultaneously trigger distal end generators per cycle. It also illustrates the capacity to repetitively align distal end sleeve assemblies behind existing rows of generators to enable pneumatic-induced kinetic force applicator to simultaneously trigger an array of generators per cycle.

### BACKGROUND OF THE INVENTION

No identified prior art describes a portable compressed gas energy storage system comprising a portable auxiliary power source, an operational rechargeable battery (Battery 1), a rechargeable battery to store generative energy (Battery 2), and a gas drive system that includes a plural of linear generators at each distal end of the separate piezoelectric housing used for reciprocating piezoelectric energy production; wherein a plural of double-sided, dual acting pneumatic drive pistons are positioned midpoint or in the middle or center of the distal ends, wherein each rod end of the plural of dual-sided, dual acting pneumatic drive pistons interconnect with a drive bar that are interconnected to the head of each drive piston rod that are pointed towards or facing each distal end of the housing; wherein the piston rods are implemented as kinetic force transfer units; wherein the two opposing piston rods of the dual-sided, dual acting pneumatic drive pistons are sharing at least one pneumatic chamber in order for pressure to simultaneously traverse or drive opposing rods out of the piston housing cylinder and up the drive path of the barrel housing; wherein pneumatic cylinder pistons are adjacent to one another; wherein these pneumatic pistons apply pneumatic force to piston rods that traverse up and down the distal ends of the barrel; wherein pressure (gas), pneumatic pistons and drive bar are claimed as the drive system; wherein the drive bars that interconnects both piston rods of the pistons engages with the linear generators when traversing back and forth simultaneously because of manual or automatic relay switches that work with an automatic or manual relay or control module to regulate the air or gas output stored in the gas compressor chamber using valves and air hoses to supply pressure that drives the pneumatic pistons that are located at the midpoint of the drive system or barrel housing; wherein an assembly is positioned at each distal end of the barrel housing that houses a manual or automated relay controller and a plural of linear generators; wherein the assembly receives kinetic pressure from the reciprocating pneumatic drive system; wherein pressure is released from the relay to an intake of valve of the double-sided, dual-acting pneumatic pistons to traverse the drive bars that interconnect with the piston rods into linear generators; wherein the drive bar engages the generators in order to transfer motion in the form of kinetic energy to the respective series of linear generators; wherein the motion of the drive bar from midpoint to a distal end simultaneously applies kinetic force to not only the series of linear generators but also applies kinetic force to distal ended manual or automatic relay controllers that connect with automatic or manual relay or control module located outside the piezoelectric housing that regulate pressure (heat) directional flow to trigger the opposing movement of pneumatic pistons; wherein manual relay or control module works with relay controllers, while optional automatic relay or control module work with a preferred time set forth in order to automatically reset the relay or control module; wherein relay or control modules regulate the pressure output stored instead of using distal end relay controllers to input and discharge pressure to and from pneumatic pistons using air hoses interconnected to the relay or control module and to valves on the pneumatic pistons; wherein, in the separated piezoelectric housing, pneumatic pistons that are midpoint to the plural of linear generators that are positioned at each distal end of the housing apply pneumatic force to the opposing piston rods that interconnect with the pneumatic pistons that provide pneumatic-induced motion to the interconnected drive bars that makes contact with linear generators at each distal end; wherein the drive bars simultaneously apply kinetic force to the respective distal end generators and relay controllers to trigger a manual relay or control module if applied; wherein a compressed gas source operated by battery 1 or a first electrical energy storage unit receiving energy from a portable auxiliary power source, namely renewables or other sources of electrical load or supply, supplies operational energy to battery 1 that supplies energy to the motorized pump of the gas compressor and valve system that works with distal ended relay controllers that connect to outside relay or control module that regulate the gas directional flow and use kinetic energy to facilitate movement and direction of the pneumatic pistons in order to push the drive bar back and forth until either the volume of the compressed gas chamber is low, power sources are depleted or the electrical energy storage units are full to capacity, the device is turned off or a killswitch command is sent from battery sensors to control modules to cease operations; wherein linear generators, also known as linear magnetic induction units, are positioned along the distal ends of the barrel housing such that upon impact with the front frames of the drive bar, said magnetic induction units shall generate electricity, which is converted by a transformer, then transferred and stored to battery 2 or electrical energy storage unit 2 for storage; wherein a transfer control can be used to switch between stored AC, direct AC and direct DC output when stored AC is not presently optional.

In this and many other respects, the Compressed Gas Energy Storage microgrid apparatus or system departs from the conventional concepts and designs of the prior, traditional, or existing compressed gas energy storage system

### SUMMARY OF THE INVENTION

The a combined heat and power system, namely a combined renewable energy and compressed gas energy storage and generation portable isothermal microgrid system, is a reciprocating bar-based barrel that uses a drive bar to transfer direct kinetic energy to piezoelectric components to then store the electrical production, all of which can be used in a microgrid configuration, that uses renewable energy, namely solar, wind, water or hydro, or other sources of electric supply to sequentially generate initial electrical energy that is stored, store pneumatic energy as compressed gas, generate high density electrical energy using stored gas against piezoelectric generators, and finally store the resulting high density electrical energy into a second battery that interconnects with renewable energy storage for bidirectional flow electrical balancing to prolong electrical recharging of storage through using multiple electrical generative sources; all of which comprises of a barrel housing with a modified drive system within the barrel housing setting where a drive bar traverses back and forth in order to transfer kinetic energy to a plural of piezoelectric components, namely linear generators and relay controllers located at distal ends of barrel housing in a mounted drive assembly that allows kinetic force application, to promote simultaneous electrical discharge and pressure (gas) discharge to promote the pneumatic rods to traverse towards opposing distal ends of the piezoelectric barrel housing. As a direct kinetic energy transferor, it uses a bar to apply pressure (gas)-induced reciprocating kinetic force application onto a plural of distal end piezoelectric components. The center of the piezoelectric barrel housing, also known as the midpoint of the distal ends of the barrel housing or drive system, is outfitted with double-sided, dual-acting pneumatic pistons that house rods that uses pressure to apply force to interconnected distal end drive bars to trigger the current discharge of linear generators from both distal ends simultaneously. The pneumatic pistons are being supplied pressure from a compressed gas source or chamber, which pushes on internal components of the pneumatic piston—rod—which in turn pushes in a reciprocating manner the drive bar toward opposing distal ends or drive assembly housing linear generators and relay controllers.

An object of the invention is to provide a housing that includes a modified drive system of the barrel housing that includes linear generators at distal ends, which are transferred linear or kinetic energy from a drive bar from the midpoint area of the barrel housing.

Another object of the invention is to provide the drive system with a force application drive bar that interconnects the piston rods that are supplied kinetic energy by the pneumatic pistons positioned at distal ends to apply kinetic force in a reciprocating manner to a drive assembly or plural of linear generators and relay controllers positioned at each distal ends.

A further object of the invention is to include pneumatic pistons at the midpoint of the distal ends of the piezoelectric housing, since the double-sided, dual acting pneumatic pistons house piston rods that use stored pressure (gas) to generate pneumatic movement. The compressed gas source or chamber will supply pneumatic force to the pneumatic pistons in order to aid the pressure (gas) in pushing the drive bar towards respective piezoelectric components, namely a plural of linear generators and relay controllers that are located at distal ends of the barrel. The drive bar engages with or applies kinetic pressure to the action relay controller that uses kinetic pressure from drive bar to send a command to the relay or control module that regulates the gas directional flow that promote movement of pistons. Relays controllers, located at each distal end, enable newly added pressure to pistons. Optional design of the automatic relay or control module can be pneumatic timing discharge-based, or pneumatic discharge that operates on timing sequence to regulate or direct pressure in or out of pistons using air hoses, instead of using distal end relay controllers to input and discharge pressure to and from pneumatic pistons using air hoses interconnected to the relay or control module and to valves on the pneumatic pistons. Pistons located at the midpoint of the distal ends are receiving newly added pressure input through air hoses supply gas to interconnect to piston valves or stems to extend their piston rods.

An additional object of the invention is to supply an auxiliary power source, namely renewables or other sources of electrical supply, to operate the compressed gas source for remote or portable power station purposes. The compressed gas source will supply pneumatic force to the pneumatic pistons in order to pushing the opposing, distal end drive bars towards both linear generators and relay controllers that are located at distal ends of the barrel housing. Each drive bar engages with the automatic or manual action controllers, which sends a command to the relay or control module to regulate the directional flow of compressed gas at a time towards one pair of midpoint pneumatic pistons or the other. Additionally, the relay or control module can utilize motion detection sensors or come equipped with a pneumatic timer to autonomously switch the directional flow of compressed gas on a timer—sequential or simultaneous manner—towards one pair of centered pneumatics pistons without the usage of automatic or manual action controllers that rely on kinetic force applications from the drive bar.

A further object of the invention is to generate high energy using a plural of magnetic induction generators for energy production purposes. Linear magnetic induction generators produce electricity upon movement of magnet back and forth inside of induction coil. Generators can include either a spring only or a first and optional spring configuration to promote push down and reset of the magnetic induction bar or magnetic induction process that results in a discharge of a current. First spring configuration has the spring positioned on one side of the metal bar to facilitate spring release and retraction processes, while the optional first and optional second spring configuration has the first spring located at the opposing side of the magnet and metal bar. Magnet can traverse back and forth within induction coil. Force is applied to the linear magnetic induction generators by the traversing kinetic motion of the drive bar. The bar applies force to the magnet set atop a compressed spring that facilitates motion between the magnetic field of the magnet and conductive coil to emit an AC electrical output. Transformers are used in conjunction with the magnetic induction generators to convert AC to DC power. A transfer control can be used to switch between stored AC, direct AC and direct DC output when stored AC is not presently optional. The linear generators work in conjunction with the system auxiliary power, namely renewables or other sources of electrical supply.

An additional object of the invention is to provide a design where multiple generators can be triggered simultaneously to produce high energy densities per reciprocating cycle. A singular pneumatic pressure input source can allow an array or series of linear generators to be influenced or triggered to simultaneously produce an electric current discharge or discharged electric current per spring reciprocating cycle. The linear generators can be aligned in an array—rows and columns—, to trigger each other, where distal end housing comprising of a plural of linear generators can be aligned in an array—columns and rows—at the rear of the prior row of linear generator-based distal end sleeve housing; wherein the rear stem or bar of the prior linear generators are elongated as a result of kinetic force applied to push down the metal bar of the linear generator; wherein the rear stems or bars can rest on a secondary drive bar or magnetic divider that rest on magnets of a secondary row of linear generators so applied kinetic force is transferred from the first row of linear generators to the second row of linear generators and other rows of linear generators following thereafter.

An additional object of the invention is to provide two electrical energy storage units that store electricity. The first electrical energy storage unit stores electricity generated from the auxiliary power source and supplies it to the motorized pump of the compressed air source; wherein the second electrical energy storage unit stores electricity generated from the linear generators and supplies electric user power. The first and second electrical energy storage units can be interconnected.

A further object of the invention is to provide access to filtered water when the system is using an ambient gas source. Moisture from an ambient gas source builds up over time within the compressed gas storage chamber as the high ratio of gas within the volume of the compression chamber heats up during compression, releasing moisture, and likewise cools down during expansion; wherein the moisture can be directed into an interconnected portable water filtration system to supply filtered water that accumulates over time, enabling the system to not only relate to the field of energy production, conservation, and transference but also relate to the field of water collection, conservation, and transference.

These together with additional objects, features and advantages of the compressed gas energy storage system or apparatus will be readily explained upon reading the following detailed description of illustrative embodiments of the portable air driven generator and storage system when taken in conjunction with the accompanying drawings.

In this respect, before explaining the current embodiments of the portable air driven generator and storage system in detail, it is to be understood that the portable air driven generator and storage system is not limited in its applications to the details of construction and arrangements of the components set forth in the following description or illustration. The concept of this disclosure may be readily utilized as a basis for the design of other structures, methods, and systems for carrying out the several purposes of the portable air driven generator and storage system.

It is therefore important that the claims be regarded as including such equivalent constructions insofar as they do not depart from the spirit and scope of the microgrid portable air driven generator and storage system. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the invention.

FIG. 1 illustrates a cross-sectional view of the embodiment of the system configuration—electric production, conservation, and transference as well as pneumatic gas conversion into filtered water—of the present invention.

FIG. 2 illustrates a detailed view of the pneumatic gas configuration only.

FIG. 3 illustrates a detailed illustration of the pneumatic gas system configuration and sequence, not only illustrating the directional pressure (heat) flow using gas hoses and valves and the componentry that are influenced by the stored gas before the gas is directed out through piston valves but also illustrating pistons with multiple chambers that can be configured to work in the system. In the process of directional gas flow that occurs in pistons that use two gas storage chambers—a front and a rear that is separated by a rod wall—to traverse the piston rod wall in one direction, the front gas storage chamber (chamber 1 is supplied pressure, making the opposing gas storage chamber (chamber 2) of the piston direct out pressure back to the valve located at the relay or control module by using air hoses used to direct pressure in and out. The wall of a rod separates the single large gas chamber of the piston into two adjacent gas storage chambers—front chamber and rear chamber—in order for pressure (heat) to be directed in or out one side of the gas storage chamber, which will direct out pressure in the adjacent gas storage chamber to traverse the piston rod and rod wall in opposing directions using the sequential process of applying pressure into chamber 1 or chamber 2 of the piston, depending on the direction that the drive bar is traversing to trigger manual relay controllers or depending on a pneumatic timing command sent from the relay or control module. One of the manual relay controllers can be designed with an extended switch arm to enable the switch to be position at the rear area of the opposing drive bar in order to be triggered, thereby changing the directional flow of pressure to traverse the drive bar.

FIG. 4 illustrates a detailed illustration of the movement of the pneumatic pistons when gas input occurs and when gas discharging occurs. Air hoses interconnect with sides or gas chambers of pistons using valves as the air hoses work as both gas admittance and simultaneously gas release units, depending on the piston gas chamber that gas is inputting and being released, as air hoses direct pressure controlled by the relay to enter one side of the piston gas chamber and release pressure using the air hoses that direct the released pressure to a release valve located at the relay or control module.

FIG. 5 illustrates a cross-sectional view of the electrical configuration only, illustrating the electrical input from the renewable energy source, the units that the battery operates, and the multiple currents—from stored AC to direct AC and DC—that the system can produce for electric users.

FIG. 6 illustrates a cross-sectional illustration of the full configuration of system as well as the electrical sequence, illustrating the directional flow of electricity produced from the push-down process of the plurality of linear generators positioned at each distal end of the barrel housing.

FIG. 7 illustrates a detailed illustration of the magnetic induction unit, illustrating the multiple linear generator designs that can work with a transformer to provide direct DC or work without a transformer to provide direct AC.

FIG. 8 illustrates a detailed illustration of the existing piezoelectric barrel housing, an illustration of the additional magnetic induction sleeves that can be interconnected to the existing piezoelectric housing and componentry of both designs, illustrating the drive system comprising of gas source, centered pistons and distal end drive bars that apply kinetic pressure to promote the push-down process of distal end piezoelectric-based influenced assembly units like a plurality of linear generators and relay controllers, as well as a plurality of additional generative cartridge sleeves per distal end to promote higher energy density output when kinetic force is applied by the drive bars.

FIG. 9 illustrates a detailed illustration of the barrel housing, illustrating the influenced assembly, namely the distal end sleeves that house piezoelectric components like the plurality of linear generators and relay controllers.

FIG. 10 illustrates a detailed illustration of the array of distal end housing comprising of a plural of linear generators that can be aligned in a column or row to the rear of a prior linear generator to use the rear stem of the prior linear generator to trigger by pushing down the magnet of the linear generator positioned behind it. A singular pneumatic pressure input source can allow an array or series of linear generators to be influenced or triggered to simultaneously produce an electric current discharge or discharged electric current per sequence of piston rod push and pull event.

FIG. 11 illustrates an embodiment of proposed application that the portable microgrid system can be adopted to, namely an electric vehicle-to-grid application, where portable electricity can be applied to an electric vehicle and electric grid.

FIG. 12 illustrates a detailed illustration of the movement of the pneumatic pistons when using a pneumatic timing relay or control module to sequentially direct gas or pressure flow to each air hose, as an alternative to using the manual relay controllers that rely on kinetic pressure from the drive bar.

FIG. 13 illustrates a detailed illustration of the movement of the pneumatic pistons when using a motion detection relay switch connected to the relay or control module, as an alternative to using the manual relay controllers that rely on kinetic pressure from the drive bar.

FIG. 14 illustrates a detailed illustration of the portable water filtration system that connects to a port on the compressor gas chamber that filters collecting moisture and converts it into drinkable water.

### DETAILED DESCRIPTION OF THE INVENTION

The following detailed description is merely exemplary in nature and is not intended to limit the scope of the invention. As used herein, the word “exemplary” or “illustrative” means “serving as an example, instance, or illustration.” Any implementation described herein as “exemplary” or “illustrative” is not to be construed as preferred or advantageous over other implementations. All of the implementations described below are exemplary implementations in the art of compressed gas energy storage system to practice the disclosure and are not intended to limit the scope of the appended claims. Furthermore, there is no intention to be bound by any expressed or implied theory presented in the preceding technical field, background, brief summary or the following detailed description.

### KEY TO NUMERICAL REFERENCES BELOW OR IN THE DRAWINGS

100—Invention—Reciprocating Bar-Based Barrel Direct Energy Transferor Piezoelectricity
109—Auxiliary power source (Renewable energy source or other source of electric supply)
101—Housing
108—Sleeve (Housing)
102—Undefined length
103—Undefined internal length or width or depth
105—Inner surface
106—Drive bar
118—Housing of the drive bar
107—Distal end (Invention)
128—Inverter
130—First electrical energy storage unit—capacitor or battery (Gas source)
131—Second electrical energy storage unit—capacitor or battery (Electric user)
134—Transfer control
135—Electrical wire
122—Pneumatic piston
104—Piston rod
120—Rod Wall
123—Spring (Optional-located within 122)
124—Piston (Internal)
133—Valves
126—Gas source
111—Compressor motor or pump
125—Gas chamber
127—Air hose
129—Relay or control module (Automatic or manual)
171—Motion detection sensor switch (Optional to work with relay)
172—Pneumatic timing release relay or control module (Optional)
132—Action relay controllers (Wireless or wired)
136—Water filtration unit
173—Gravel
174—Sand
175—Charcoal
176—Cheesecloth or coffee filter
177—Filtered water
137—Port
138—Moisture
139—Pressure (Heat)
140—Magnetic induction generators
141—Magnet
142—Induction coil
143—First spring
146—Second spring (Optional)
144—Transformer
145—Metal Bar
147—Magnetic shielding wall divider
170—Electric user

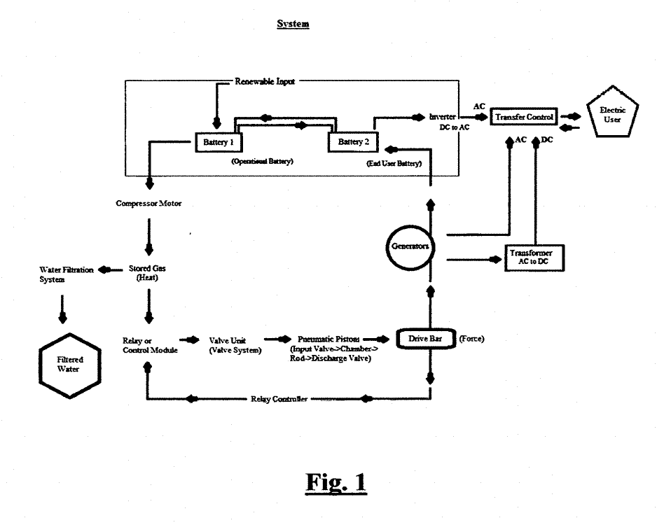

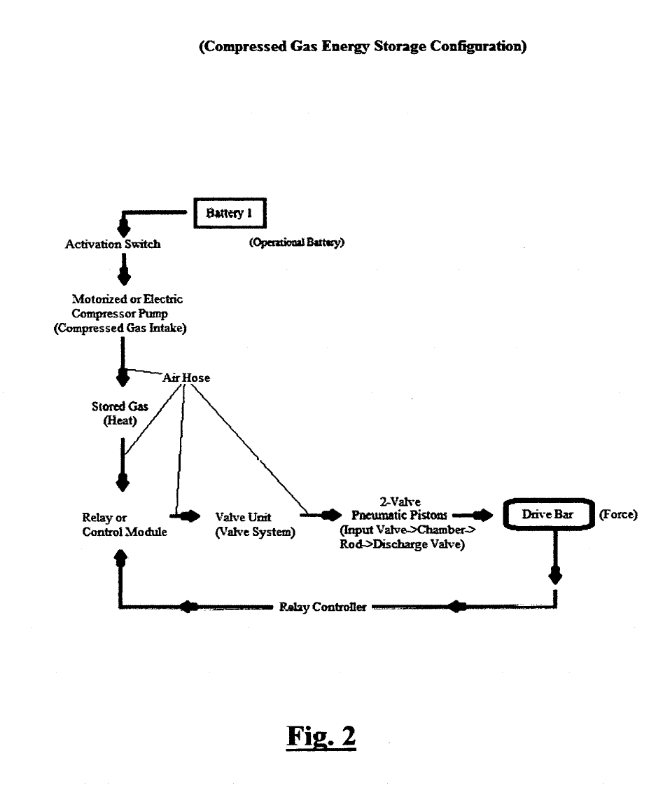

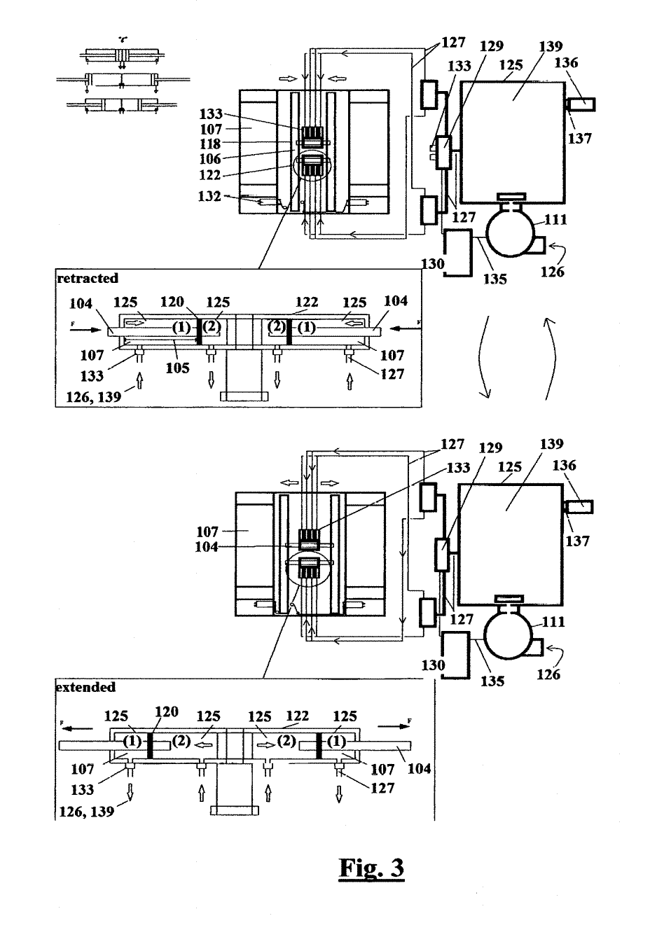

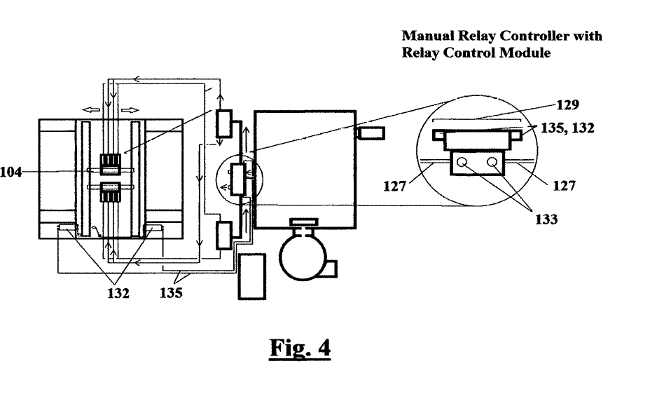

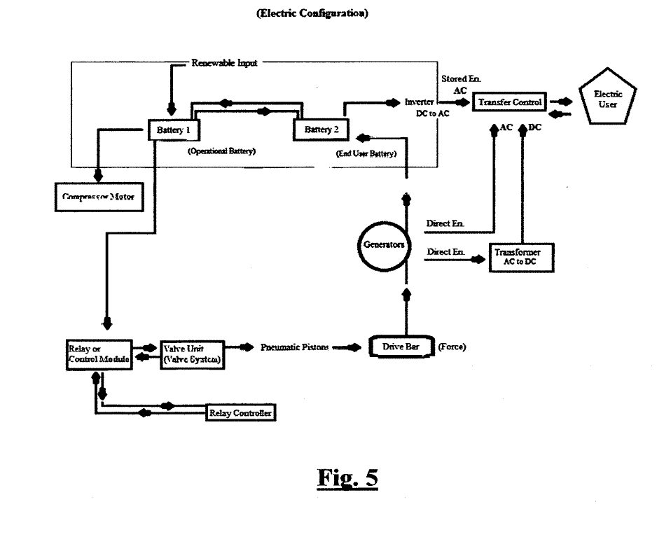

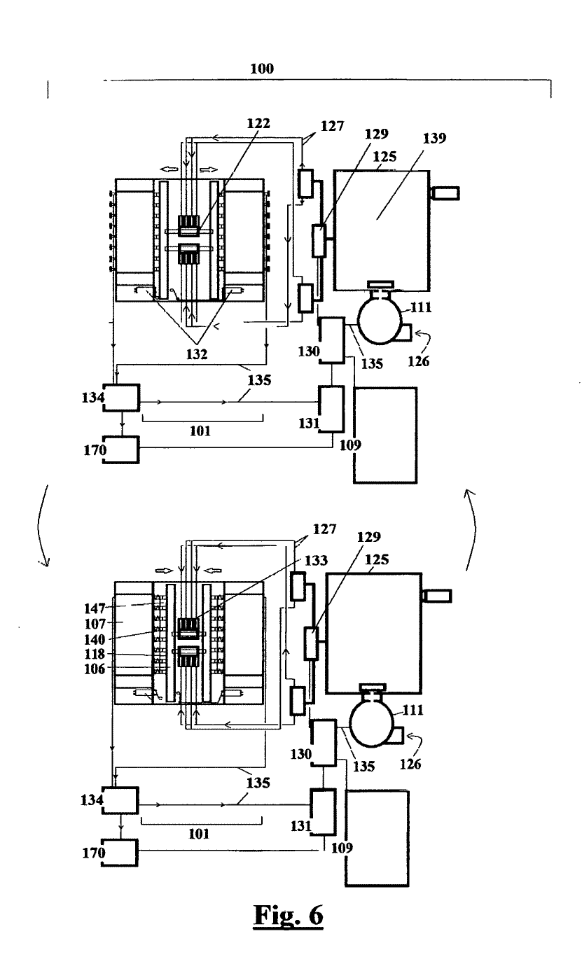

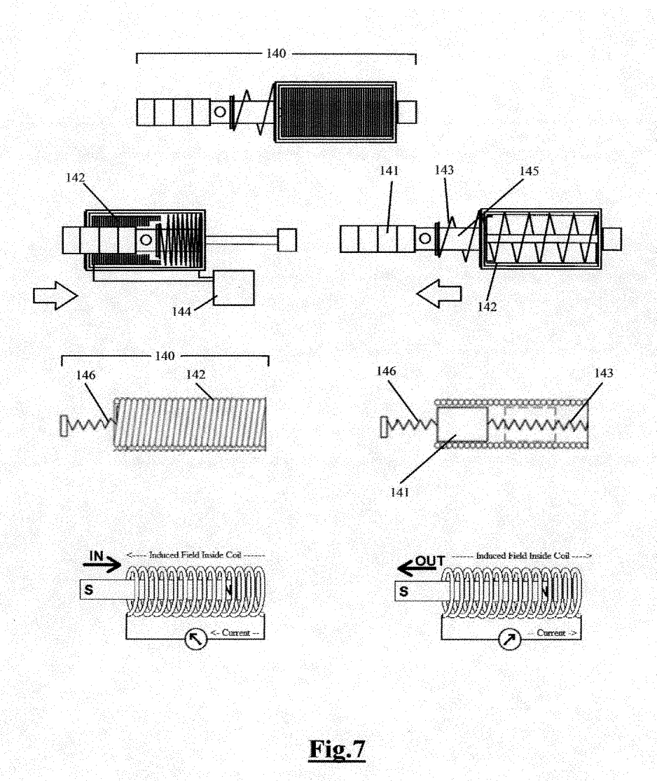

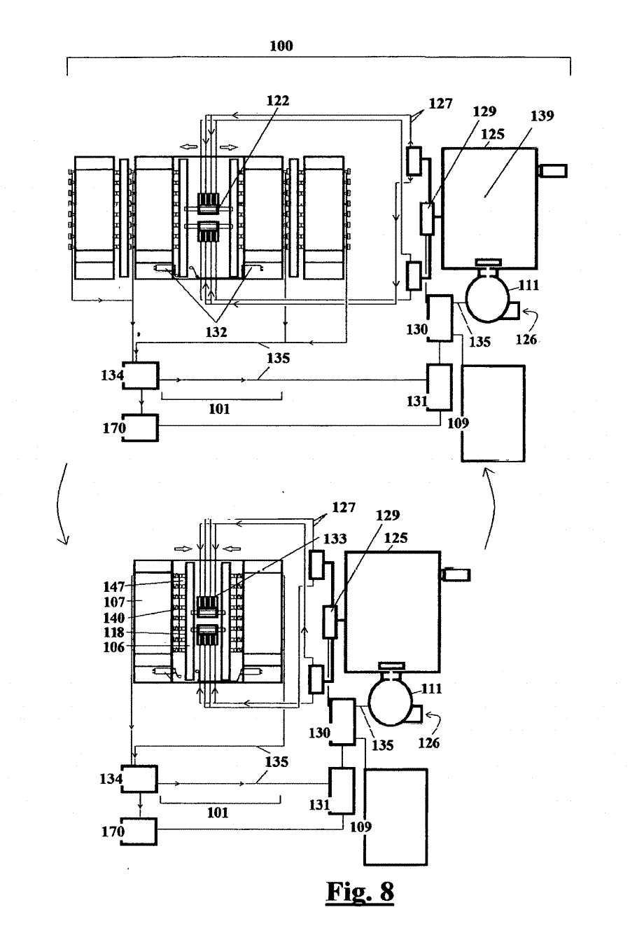

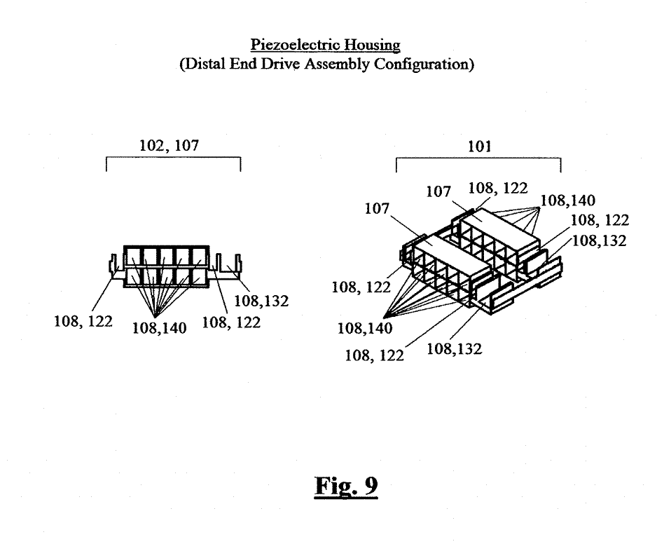

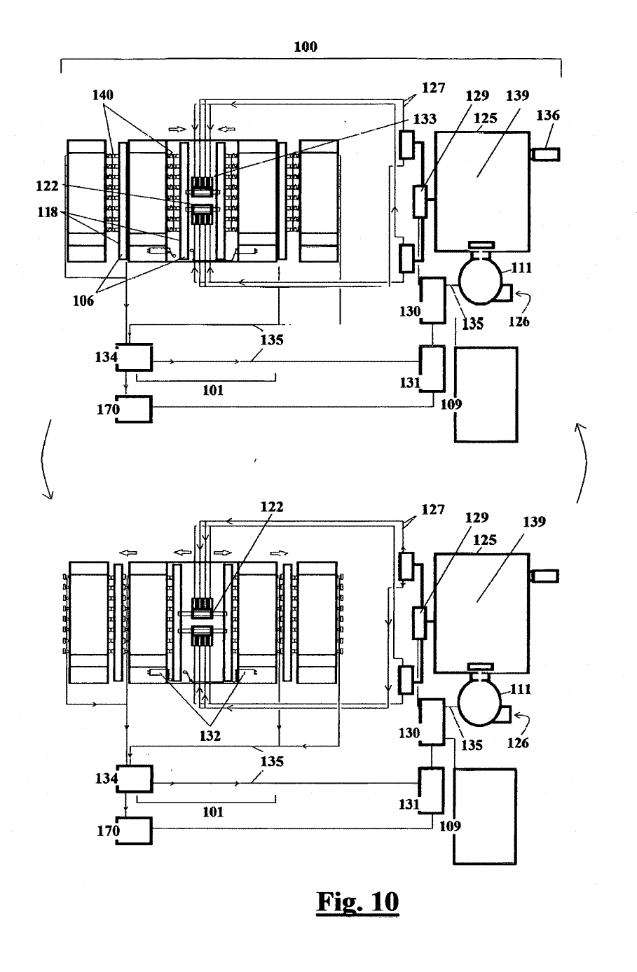

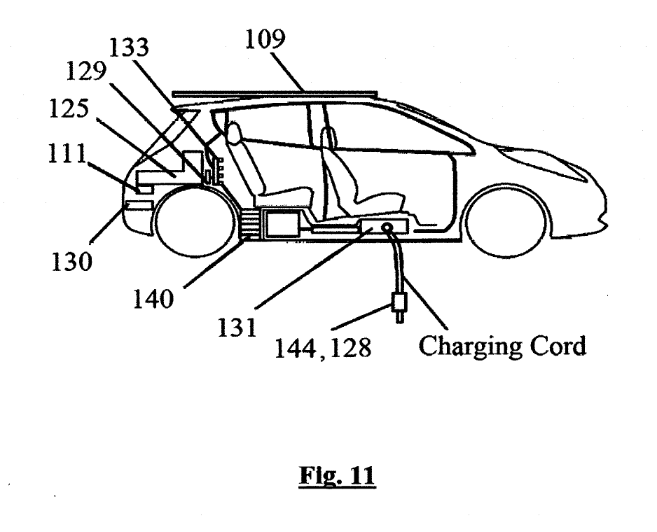

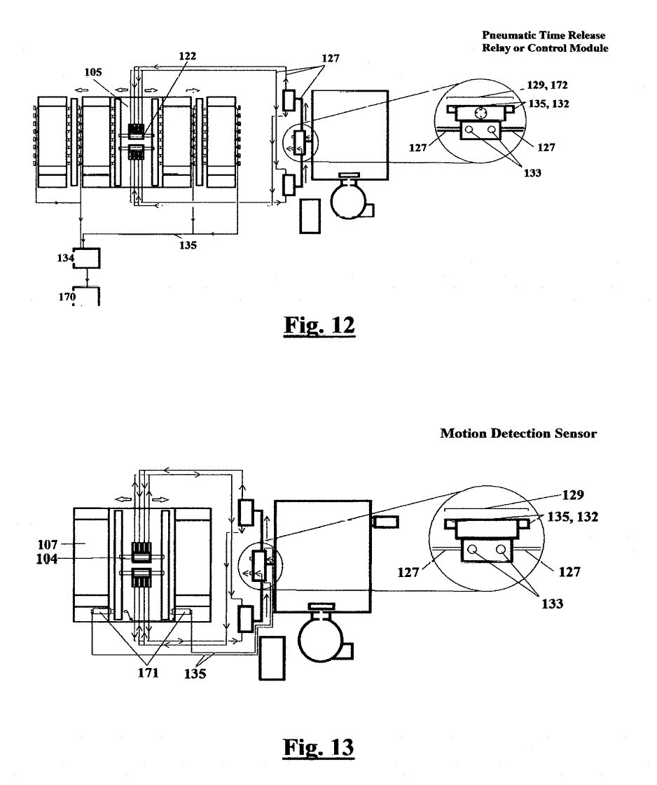

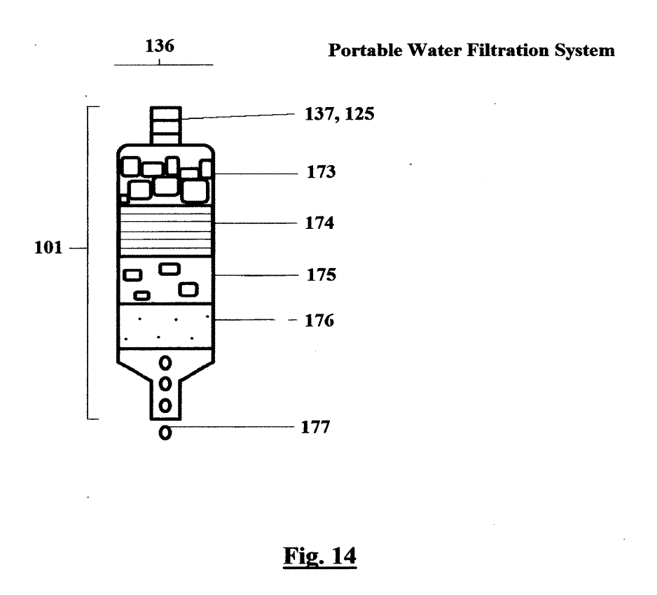

Detailed reference will now be made to a preferred embodiment of the present invention, examples of which are illustrated in FIGS. 1-14. The compressed gas energy storage system, namely a reciprocating bar-based barrel direct energy transferor piezoelectricity system 100 (hereinafter “invention”) comprising of a barrel housing with a plural of traversing drive bars as the direct energy transferor and piezoelectric componentry, includes a barrel housing 101 of an undefined length 102 and undefined internal length or width or depth 103. That being said, the barrel housing 101 is of hollowed construction, is rectangular in shape, includes distal ends 107 that interconnect using side rails, and has clearance space in between the distal ends. Each distal end 107 is made up of multiple sleeves 108 to house piezoelectric components as well as sleeves 108 to include linear generators 140 and relay controllers 132 extending lengthwise along an inner surface 105 with which a drive bar 106 that is interconnected with the piston rods 104 of pneumatic pistons 122 that are centered in the clearance space 105 between the distal ends 107 of the housing 101 that engages the linear generators 140 and traverses each distal end drive bar 106 back and forth between distal ends 107.

The barrel housing 101 includes a plural of linear generators 140 at the distal ends 107 positioned in housing sleeves 108, and draw kinetic energy from the drive bar 106 when in contact therewith. It shall be noted that the invention 100 is designed in such a way that the drive bar 106 is mobile and traverses back and forth between the distal ends 107 in order to transfer kinetic energy to the linear or magnetic induction generators 140 for electrical production when arriving at the distal ends 107 by the use of a compressed gas source 126 to supply pressure (heat) 139. That being said, the housing of the drive bar 118 applies kinetic force stored therein when communicated with the linear or magnetic induction generator 140; so upon contact, and upon moving away from said linear or magnetic induction generator 140 and moving towards an opposing distal end, said housing of drive bar 118 is imparted new kinetic force by compressed gas source 126 that traverse pneumatic pistons 122 in order to apply new level of kinetic force therein for transference to the piezoelectric components positioned in housing sleeves 108, namely relay controllers 132 and linear or magnetic induction generators 140 at the opposing distal end 107, etc.

The plural of magnetic induction generators 140 produce electricity, which is transferred to the second electrical energy storage unit 131.

Pneumatic pistons 122, positioned between or midpoint of distal ends 107 of piezoelectric housing, work in unison with interconnected piston rods 104 and drive bar 106 to apply applicable force to traverse each drive bar 106 back and forth along the inside of the barrel housing 101. The centered double-sided, dual-acting pneumatic pistons 122 comprise of a plural of piston rods 124 that can traverse in opposing directions when pressure 139 is introduced into their gas chambers 125 can include a spring 123 coupled with a piston 124. Regulated by relay controllers 132 that send a command to the relay or control module 129 that regulates the directional flow of gas 126 into midpoint pneumatic pistons 122, the piston 124 is connected to a gas chamber 125, which supplies compressed gas 126 to all of the pistons 124 via compressed air hoses 127. As an alternative to using relay controllers 132, the relay or control module 129 can utilize motion detection sensor switches 171 or can use a pneumatic timing release relay or control module 172 to autonomously switch the directional flow of compressed gas 126 on a timer or sequential manner towards one pair of centered pneumatics pistons 122 without the usage of automatic or manual action controllers 132 that rely on kinetic force applications from the drive bars 106. Located at each distal end 107, motion detection sensor switches 171 select the drive bar 106 region to monitor movement using an emitted light 178 to compare sequential images, changes or interruption in light pattern; and if enough of the light 178 have changed between those frames, the software determines something moved and send the relay 129 an alert to trigger motion of the pneumatic pistons 122 by sending command to relay 129 to release gas as pressure into targeted air hoses 127. Pneumatic timing release relay or control module 172 releases gas 126 as pressure 139 to air hoses 127 in a sequence based on timing action that is halted by removing voltage from the coil 142 with time; when voltage is applied to the coil 142, the contacts energize and de-energize alternatively, making on and off cycle timing lengths adjustable so the time release can reoccur or happen again. Air hoses 127 interconnect relay or control modules 129 with valves 133 of pneumatic piston 122 and its internal piston 122 or chambers 125 as the air hoses 127 work as both gas admittance and simultaneously gas release units, depending on the piston gas chamber 125 distal end 107 that gas 126 working as pressure 139 is being directed—inputted and released—as air hoses 127 direct pressure 139 controlled by the relay 129 to enter one side of the piston gas chamber 125 and release pressure 139 using the air hoses 127 that direct the released pressure 139 to a release valve 133 interconnected with the relay or control module 129.

The gas chamber 125 is supplied compressed gas from a compressed gas source 126 and stores it as pressure (heat) 139. Moisture 138 from a gas source 126 builds up over time within the compressed gas storage chamber 125 as the high ratio of gas within the volume of the compression chamber heats up during compression, releasing moisture 138, and likewise cools down during expansion. The water filtration unit 136, which can consist of a rectangular, bottleneck housing 101 with filtration layers like gravel 173, sand 174, charcoal 175 and a cheesecloth or coffee filter 176 to filter water contaminants, can interconnect with an intake/outtake port 137 of the gas storage chamber 125 so moisture 138 can be directed into the water filtration system 136 to supply filtered water 177 that accumulates over time, enabling the system 100 to not only relate to the field of energy production, conservation, and transference but also relate to the field of water collection, conservation, and transference.

The magnetic induction generators 140 produce electricity by absorbing kinetic pressure from the drive bar; wherein the kinetic pressure is transferred into movement of a magnet 141 back and forth inside of an induction coil 142. Each magnet 141 magnetizes a metal bar 145 that works with a first spring 143 to reset the metal bar 145 back to its original position and reciprocate the kinetic pressure. Magnets can be separated by magnetic shielding divider or wall 147 to prevent magnetic interference. The generator can include an optional second spring 146 if necessary, to assist in reciprocating the weight of the combined magnet and metal bar. The first spring 143 is located on a side of the magnet 141 opposite of the optional second spring 146. The first spring 143 connects the magnet 141 to the distal end 107 of the barrel housing 101 such that the magnet 141 can travel back and forth within the induction coil 142. The optional second spring 146 extends away from the adjacent distal end 107 of the housing 101. The magnet 141 or first spring 143 is responsible for hitting against the drive shaft or bridge bar 106. It shall be noted that the magnet 141 produces electricity as it traverses back and forth inside the induction coil 142 therein.

The movement of the magnet 141 back and forth within the induction coil 142 is accomplished by virtue of the first spring 143 and the optional second spring 146 in communication between the drive bar 106 and the distal end 107 of the housing 101. It shall be noted that as the drive bar 106 traverses back and forth inside of the barrel housing 101, the housing of the drive bar 118 applies kinetic pressure to the first spring 143 to extend and retract, which causes the magnet 141 to magnetize the metal bar to move back and forth inside of the induction coil 142 thereby producing electricity each time the housing of the drive shaft bar 118 traverses to each distal end 107. The AC electricity that is produced by the linear or magnetic induction generators are converted to DC by transformers 144. A transfer control 134 can be used to switch between stored AC, direct AC and direct DC output when stored AC is not presently optional.

The linear or magnetic induction generators 140 can be aligned in an array—rows and columns—, to trigger each other within their respective stationary sleeves 108, where distal end housing 101 comprising of a plural of linear generators 140 can be aligned in an array—columns and rows—at the rear of the prior row of linear generator-based distal end sleeve housing 101; wherein the rear stem or metal bar 145 of the prior linear generators 140 are elongated as a result of kinetic force applied to push down the metal bar 145 of the linear generator 140; wherein the rear stems or metal bars 145 can rest on a secondary drive bar 106 performing as a magnetic divider 147 that rest on magnets 141 of a secondary row of magnetic induction generators 140 so applied kinetic force is transferred from the first row of linear generators 140 to the second row of magnetic induction generators 140 and other rows of linear generators 140 following thereafter. A singular pneumatic pressure input source 139 can allow an array or series of linear or magnetic induction generators 140 to be influenced or triggered to simultaneously produce an electric current discharge or discharged electric current per spring reciprocating cycle.

The first energy storage 130 can be interconnected with the second energy storage 130; wherein electricity produced by the magnetic induction generators 140 can be transferred by a wire 135 to supply electricity to the second electrical energy storage unit 131—capacitor and/or battery—and then an inverter 128 for electric user energy conversion purposes; while the first electrical energy storage unit 130 stores energy from a portable auxiliary power source 109, namely a renewable energy source or other source of electric supply, to supply power to the on demand motor 111 of the compressed gas source 126. That being said, the compressed gas source 126 is commonly a gas compressor that requires electricity from first battery 130 in order to operate a motor 111 to facilitate the compression and storage of gas.

The stored gas source 126 which is transferred as pressure (heat) 139 by air hoses 127 using input and discharge valves 133 to and from the gas chamber 125, which then transfers the compressed gas 126 as pressure (heat) 139 back to the piston diaphragm 124 of the pneumatic pistons 122. Double-sided, dual-acting pneumatic pistons 122 comprise of a plural of piston rods 124 that can traverse in opposing directions when pressure 139 is introduced into their gas chambers 125 can include a spring 123 coupled with a piston 124. Pneumatic pistons 122 are positioned at the center of the distal ends 107 of the housing 101 as a drive assembly to reciprocatingly convert high ratio of stored pressure (heat) 139 stored within the gas chamber 125 to enable the mechanical motion of the piston rods 124 as air hoses 127 connect to input and discharge valves 133 of pneumatic pistons 122, which is namely a pneumatic force component with an internal that includes a gas storage chamber 125 with valves 133 located at each distal end 107 that use a piston rod wall 120 in the gas storage chamber 125 as a pressure (heat) divider for each distal end 107 of the gas storage chamber 125 with input and discharge valves 133, allowing chamber 1 to be the numerical reference for the front gas storage chamber 125 of the piston and chamber 2 to be the numerical reference for the opposing gas storage chamber 125 of the piston 122. The relay or control module 129 directs pressure 139 to respective air hoses 127 to supply pressure 139 to respective distal end gas storage chambers 125 of the piston 122 to traverse the piston rod 104. As the front gas storage chamber (chamber 1) 125 is supplied pressure, making the opposing gas storage chamber (chamber 2) 125 of the piston 122 discharge pressure 139 back to the release valve 133 located at the relay or control module 129 by using air hoses 127 to input and discharge pressure 139. The wall of a rod 120 separates the single gas chamber 125 of the piston 122 into two adjacent gas storage chambers 125 in order for pressure (heat) 139 to input one side of the gas storage chamber 125, which will discharge pressure 139 in the adjacent gas storage chamber 125 to traverse the piston rod 124 or rod wall 120. The volume of gas source 126 compresses on one end of the piston rod 124 or rod wall 120 while expanding it as pressure (heat) 139 on the opposing end to traverse the rod 124 back and forth in a push and pull manner in a certain direction. Pneumatic pistons 122 are designed with a gas input and discharge valves 133 that are supplied gas 126 as pressure 139 by air hoses 127 that make up the valve system comprising of electromagnetic solenoids and standard valves 133 that is interconnected with the gas storage source 126. Each gas storage chamber 125 is designed with either a valve 133 for gas input/discharge processes or a combined gas storage chamber 125 and spring 123 configuration where pressure 139 is applied to one end of the piston 124, facilitating the spring 123 to first retract then extend back to its original position. The pressure 139 input on one side of the piston 124 enables pressure (heat) 139 to be discharged on the other end of the piston 124 if the pneumatic piston has two gas chambers 125 with two valves 133, or if the pneumatic piston 122 has a pressure (heat) 139 and spring 123 configuration, then a single valve 133 can be used to input and discharge gas 126 to move the rod 104 forth while the spring 123 is used to apply opposing force as it retracts and extends, thereby applying opposing force from using the inner surface 105 of the pneumatic piston 122. There will be sequential pressure discharging on one side of the pneumatic piston rod 104 to traverse or push and pull the piston rod 104 to achieve sequential movement in the opposite direction. The rod 104 or rod wall 120 is linked to the internal piston 124. The piston 124 interconnects with piston rods 104 that interconnect with the drive bar 106. Pressure (heat) 139 released or regulated to centered pneumatic pistons 122 by relay or control module 129 that uses manual or automatic activation relay controllers 132 that are positioned at each distal end of the barrel housing 101 to release pressure 139 that will move piston rod 104 a certain length 102 until the pressure (heat) 139 is discharged out a discharge valve 133 to facilitate the sequence of pressure input and discharge provided by either stored compressed heat gas source 126 or other acting on the piston 124 to achieve movement in the opposing direction to traverse the rod 104, thereby traversing the drive bar 106 to promote pneumatic force storage manipulation onto distal end drive assembly of the housing 101 that includes a relay controller switch 132 and a plural of linear generators or a pneumatic timing release relay or control module 172 and no relay controller 132. Opposing each other, each side of the gas storage chamber 125 that are located within the pneumatic pistons 122 that are located at the center or midpoint of each distal end 107 of the piezoelectric housing 101 is directed pressure 139 to traverse the rod walls 120 of each plural of double-sided, dual-acting pneumatic pistons 122 simultaneously. The specification of the piezoelectric housing 101 includes midpoint double-sided, dual-acting pneumatic pistons 122 that have opposing piston rods 104 that face each distal end 107. With internal numerical references (chamber 1) and (chamber 2) of the pneumatic piston 122, when traversing the rod wall 120 of the piston in one direction, this process requires pressure 139 directed by air hoses 127 that are interconnect with valves 133 to simultaneously fill not only the gas storage chambers 125 (chamber 2), which will carry the discharged pressure 139 out of the system 100 using air hoses 127 to release the pressure 139 out of the relay exit valve 133 in order to prepare for the respective discharge of pressure 139 out of the originally-filled gas storage chamber 125 (chamber 2) in order to fill the opposing gas storage chamber 125 (chamber 2) so the piston 124 will motion in a reciprocating manner to move and then reset itself to its original position as pressure 139 is input and discharged out the release valve 133 of the relay or control module 129 using either optional pneumatic timing release relay or control module 172 or manual relay controllers 132 with conventional relay or control module 129.

It shall be noted that each midpoint between the distal ends 107 of the housing 101 may include at least one double-sided, dual-acting pneumatic piston 122, while the distal end 107 of the housing 101 may include at least one magnetic induction generator 140 per distal end 107.

The invention 100 may include manual action controllers 132 that are positioned at both distal ends 107 of the housing 101. The manual action relay controllers 132 operate manually thru piezoelectric means when force is applied to their trigger which sends a command to the relay or control module 129 that regulate the released direction of the compressed gas 126 to pneumatic pistons 122 located at midpoint between the distal ends 107. Optional automatic relay or control module 129 that works on a timing release relay or control module 172 instead of using distal end relay controllers 132 to input and discharge pressure 139 to and from pneumatic pistons 122 using air hoses 127 interconnected with the relay or control module 129 and to valves 133 on the pneumatic pistons 122. Pneumatic timing release relay or control module 172 releases gas 126 as pressure 139 to air hoses 127 on a timing release control based on timing action that can continue to do over until ceased by removing current from its coil 142 with time.

The essential characteristics of the compressed gas and storage invention or apparatus is as followed: a combined heat and power system, the reciprocating bar-based barrel direct energy transferor is designed to work in conjunction with external auxiliary power sources renewable energy sources or other sources of electric supply to generate compressed gas; wherein the compressed gas resource can then be utilized to apply kinetic pressure to an alignment or plural of linear or magnetic induction generators to produce high energy densities and store the electricity for electric users, enabling the device to function as a portable generator and power station since its design allows it to store the energies of independent renewable auxiliary energy sources and apply a fraction of the accumulated energy to generate compressed gas with high volumes of pressure to trigger a plural of novel generators that are standing by at each distal end. In summation, the gas driven generator and storage system collects renewable energies, generates electricity and stores power in all sizes, making it appropriate for multiple applications, including handheld power, home power, regional power and EV-to-grid.

The barrel housing configuration includes a bar that uses compressed gas to traverse back and forth in order to transfer kinetic pressure to a drive assembly configuration of linear or magnetic induction generators and relay controllers provided at distal ends of barrel housing. The interior of the housing is outfitted with double-sided, dual-acting pneumatic piston positioned at the center or midpoint between the distal ends of the housing, where the pistons house rods that simultaneously traverse a plural of drive bars into linear generators to produce electricity as pressure is supplied and discharged to the internal gas chambers of the pistons to traverse the opposing piston rods simultaneously towards their distal end generators. This design will enable the pneumatic pistons to utilize compressed gas to facilitate movement of the piston rods. A drive bar is used as a bridge to interconnect one piston rod to the other. The drive bars allow for the two pneumatic pistons positioned at midpoint between the distal ends of the piezoelectric housing to work in sequential unison when applying kinetic force to distal ended linear or magnetic induction generators.

In addition, the linear or magnetic induction generators can be aligned in an array—rows and columns—, to trigger each other, where distal end housing comprising of a plural of linear generators can be aligned in an array—columns and rows—at the rear of the prior row of linear generator-based distal end sleeve housing. The rear stem or bars of the prior linear generators are elongated as a result of kinetic force applied to push down the metal bar of the linear generator. The rear stems or bars can rest on a secondary drive bar or magnetic divider that rest on magnets of a secondary row of linear generators so applied kinetic force is transferred from the first row of linear generators to the second row of linear generators and other rows of linear generators following thereafter; wherein a single pneumatic pressure input source will allow an array or series of linear generators to be influenced or triggered to simultaneously produce an electric current discharge or discharged electric current per spring reciprocating cycle.

The derived electricity from the generators, along with the initial operational energy, which is an auxiliary power source, namely a renewable energy source or other source of electric supply, are then stored into electrical energy storage units. The pneumatic pistons are supplied compressed gas from a compressed gas source, which receives electricity from the first electrical energy storage unit, namely the electrical energy storage unit that receives the initial operational energy, which is an auxiliary power source. In return, upon activation, the pneumatic pistons utilize the compressed gas to apply work to interconnected drive bar inside the barrel housing to awaiting piezoelectric components, namely a plural of linear generators and relay controller that are connected to the relay or control module that regulate gas directional flow. The traversing of the drive bars will continue until either the system activation switch is turned off, or the electrical energy storage units are filled to capacity or the electrical energy storage units are depleted or if the compressed gas resource depletes.

With respect to the above description, it is to be realized that the optimum dimensional relationship for the various components of the invention 100, to include variations in size, materials, shape, form, function, and the manner of operation, assembly and use, and all equivalent relationships to those illustrated in the drawings and described in the specification are intended to be encompassed by the compressed gas energy storage invention 100.

It shall be noted and readily recognized that numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A combined heat and power system, namely a combined renewable energy and compressed gas energy storage and generation microgrid system for energy production, conservation, and transference, having a housing and cross-sectional components either mounted in or outside the housing; wherein the combined renewable energy and compressed gas energy storage and generation microgrid system comprising:
a) a separate housing used for reciprocating piezoelectric energy production using centered double-sided, dual-acting pneumatic pistons to traverse interconnected kinetic drive bars onto relay controllers and generators;
b) a motorized gas compressor used to convert and store gas for pneumatic force applications using pneumatic pistons and other pneumatic components;
c) a plurality of linear generators that are positioned at each distal end of the separate housing used for piezoelectric energy production;
d) a plurality of batteries, where an operational battery supplies power to the motorized gas compressor and support battery receives energy from piezoelectric energy production derived from linear generators;
e) an auxiliary renewable energy source or other source of electric supply, where auxiliary energy is supplied to the operational battery for systemic operations: and
f) a portable water filtration system that connects to the motorized gas compressor.

2. The combined renewable energy and compressed gas energy storage and generation microgrid system of claim 1, in which housing barrel is of an undefined length having an undefined inner diameter, is of inner hollowed construction, is rectangular in shape, and includes distal ends that interconnect using side rails; in which each distal end is made up of multiple sleeves to house piezoelectric components as well as sleeves to include linear generators and relay controllers extending lengthwise along an inner surface with which a drive bar that is interconnected with the piston rods of pneumatic pistons that are centered in the clearance space between the distal ends of the housing that engages the linear generators and traverses each distal end drive bar back and forth between distal ends; wherein and gas compressor components as well as auxiliary power source and batteries are located outside the barrel housing as the housing is configured to promote electrical production using pneumatic induction and transference.

3. The combined renewable energy and compressed gas energy storage and generation microgrid system of claim 1, where a compressor motor converts the outside compressed gas source into stored heat in a gas chamber that is used to supply pneumatic force to the pneumatic pistons in order to aid the gas in pushing the drive bars toward piezoelectric components, namely a plurality of linear generators and a relay controller that is located at distal ends of the barrel; in which the drive bar engages with or applies kinetic pressure to the action relay controllers which sends a command to optional manual relay or control module to regulate the directional flow of input and discharge pressure (heat) directed into the midpoint double-sided, dual-acting pneumatic pistons; wherein relay controllers, which are located at each distal end, enable newly added pressure to pistons as the automatic or manual relay controllers are connected to the relay or control module that regulates gas pressure directional flow; wherein as an alternative of using relay controllers, the automatic relay or control module can utilize motion detection sensors or can come equipped with a pneumatic timer to autonomously switch the directional flow of compressed gas on a timer or sequential manner towards one pair of midpoint pneumatics pistons without the usage of automatic or manual action controllers that rely on kinetic force applications from the drive bars; whereas pistons are receiving newly added pressure input through air hoses supply gas to interconnected to piston valves to extend their piston rods and will sequentially discharging pressure through piston valves to retract their piston rods, thereby traversing the interconnected drive bar in a reciprocating manner since the drive bar is interconnected with the piston.

4. The combined renewable energy and compressed gas energy storage and generation microgrid system of claim 2, where the piezoelectric housing includes a drive system that includes a plural of traversing drive bars that are able to traverse the length of the barrel housing with respect to the length of pneumatic pistons rods; the pneumatic pistons are positioned at the center of each distal end of the barrel housing; in which drive bar is rectangular in shape, is of undefined length and diameter, and includes a sleeve that facilitates the interconnection of the piston rods; wherein the sleeve of the drive bar is engaged upon the piston rods such that as the drive bar goes from one distal end to another distal end using the piston rods.

5. The combined renewable energy and compressed gas energy storage and generation microgrid system of claim 4, where the housing or surface of reciprocating drive bars is responsible for the kinetic engagement and transference of kinetic force to a plurality of linear or magnetic induction generators when in contact.

6. The combined renewable energy and compressed gas energy storage and generation microgrid system of claim 1, in which double-sided, dual-acting pneumatic pistons, located at the center of each distal end of the barrel housing, are responsible for traversing the interconnected drive bars back and forth along the inside of the barrel; where the rod of the piston is interconnected with the drive bar to promote pneumatic-induced movement; in which the pistons work with the high ratio of stored gas within the volume of the compression chamber that heats up during compression and likewise cools down during expansion; in which stored heat as pressurized gas is supplied to the pistons using gas hoses and input and discharge valves or pneumatic spring configuration to traverse the piston, which in turn moves the piston rod a certain distance until the pressure is discharged out a discharge valve to facilitate the pressure input and discharge process when the drive bar applies kinetic energy to the opposing relay controller that is connected to an outside relay or control module that regulates directional gas pressure flow; where compressor gas source, namely outside gas, is converted into stored heat by the compressor motor, which is then stored in a chamber and supplied to the pneumatic system.

7. The combined renewable energy and compressed gas energy storage and generation microgrid system of claim 1, in which components of the opposing influenced assembly located in each sleeve of the housing that the drive bar triggers are linear magnetic induction generators that produce electricity upon movement of magnet back and forth inside of induction coil; where generators can include either a spring only or a first and optional spring configuration to promote push down and reset of the magnetic induction bar or magnetic induction process that results in a discharge of a current; wherein first spring configuration has the spring positioned on one side of the metal bar to facilitate spring release and retraction processes, while the optional first and optional second spring configuration has the first spring located at the opposing side of the magnet and metal bar; in which magnet can traverse back and forth within induction coil.

8. The combined renewable energy and compressed gas energy storage and generation microgrid system of claim 7, where magnet and first spring extends away from each distal end of the barrel, and is responsible for hitting against said drive bar; wherein the magnet traverses back and forth within induction coil to discharge a current; in which movement of the magnet back and forth within the coil is accomplished by virtue of first spring only or a configuration of first and optional second spring; where drive bar traverses to each distal end of barrel housing in a reciprocating manner to facilitate any applied kinetic pressure associated with movement by using drive bar frame as kinetic force application as it traverses back and forth within the barrel.

9. The combined renewable energy and compressed gas energy storage and generation microgrid system of claim 8, where AC electricity produced by linear magnetic induction generators when kinetic pressure is applied by drive bar or drive bar housing is transferred to transformer that converts AC to DC current; in which a transfer control can be used to switch between stored AC, direct AC and direct DC output when stored AC is not presently optional; wherein electricity produced by magnetic induction is then received by battery 2 or second electrical energy storage unit by wire or wireless induction.

10. The combined renewable energy and compressed gas energy storage and generation microgrid system of claim 1, where gas source receives electricity from battery 1 or first electrical energy storage unit, which receives auxiliary power from interconnected, external, portable and renewable power source or other source of electric supply, where the renewable power source is an energy source operating on a resource that can renew itself like solar, wind, etc.

11. The combined renewable energy and compressed gas energy storage and generation microgrid system of claim 1, where manual or automatic activation switch is used to start the microgrid system, namely grids that can separate itself from the traditional grid to operate independently; wherein the microgrid activation switch interconnects battery 1 or the first electrical energy storage unit to operational componentry, including the relay or control module and motorized pump of gas compressor unit; in which pneumatic pressure as force derived from the gas storage chamber of the compressor unit triggers components of the influenced assembly located in each sleeve of the housing that the drive bar, namely wired or wireless relay controller switches that are positioned at each distal end of the barrel housing to trigger pneumatic piston movement.

12. The combined renewable energy and compressed gas energy storage and generation microgrid system of claim 6, where double-sided, dual-acting pneumatic pistons, or pistons with opposing rods that face opposing distal ends of the housing that can simultaneously traverse in and out in a reciprocating, push pull manner, are positioned at the center of each distal end of the barrel housing to convert in a reciprocating manner high ratio of pressure as heat stored within the gas chamber into mechanical motion using their internal componentry as air hoses connect to input and discharge valves of pneumatic pistons, namely a pneumatic force component with an internal surface that includes a gas storage chamber with valves located at the center of each distal end of the housing that use a piston rod wall in the gas storage chamber as a pressure (heat) divider for each distal end of the gas storage chamber with input and discharge valves, allowing chamber 1 to be the numerical reference for the front gas storage chamber of the piston and chamber 2 to be the numerical reference for the opposing gas storage chamber of the piston; wherein the relay or control module directs pressure to respective air hoses to supply pressure to respective distal end gas storage chambers of the piston to traverse the piston rod; in which, as the front gas storage chamber (chamber 1) is supplied pressure, making the opposing gas storage chamber (chamber 2) of the piston discharge pressure back to the release valve located at the relay or control module by using air hoses to input and discharge pressure; in which the wall of a rod separates the single gas chamber of the piston into two adjacent gas storage chambers in order for pressure (heat) to input one side of the gas storage chamber, which will discharge pressure in the adjacent gas storage chamber to traverse the piston rod and rod wall; wherein the volume of gas compresses on one end of the rod wall while expanding it on the opposing end to traverse the rod back and forth; in which pneumatic pistons are designed with a gas input and discharge valves that are supplied gas as pressure by air hoses that make up and work with the valve system that is interconnected with the relay or control module that interconnects with the gas storage source; wherein air hoses interconnect with sides or gas chambers of pistons using valves as the air hoses work as both gas admittance and simultaneously gas release units, depending on the piston gas chamber distal end that gas working as pressure is being directed—inputted and released—as air hoses direct pressure controlled by the relay to enter one side of the piston gas chamber and release pressure using the air hoses that direct the released pressure to a release valve interconnected with the relay or control module; where each piston gas storage chamber is designed with either a valve for pressure input and discharge processes or a combined gas storage chamber and spring configuration; wherein pressure is applied to one end of the piston, facilitating the spring to first retract then extend back to its original position; in which the pressure input on one side of the piston enables pressure (heat) to be discharged on the other end of the piston if the pneumatic piston has two gas chambers with two valves, or if the pneumatic piston has a pressure and spring configuration, then a single valve can be used to input and discharge gas to move the rod forth while the spring is used to apply opposing force as it retracts and extends, thereby applying opposing force from using the inner wall of the pneumatic piston; where there will be sequential pressure discharging on one side of the rod wall to traverse the piston rod to achieve sequential movement in the opposite direction; wherein the rod wall is interconnected to the rod, which is interconnected to the internal piston; in which the piston interconnects with rods that interconnect with the drive bar; in which compressed heat is released or regulated to midpoint pistons by manual or automatic activation relay controllers located at each distal end will send a command to the relay or control module that regulates the gas or pressure directional flow to direct pressure to move piston rod a certain length until the compressed heat is discharged out a discharge valve to facilitate the sequence of pressure input and discharge provided by either stored compressed heat or other acting on the piston or piston rod to achieve movement in the opposing direction to traverse the rod to promote pneumatic force storage manipulation onto distal end influenced assembly of the barrel housing that includes a relay controller and a plurality of linear generators or a pneumatic timing release relay or control module and no relay controller; where, opposing each other, each side of the gas storage chamber that are located within the pneumatic pistons that are located at each distal end of the piezoelectric housing is directed pressure to traverse the rod walls of each distal end pneumatic piston simultaneously; wherein the specification of the piezoelectric housing includes double-sided, dual-acting pneumatic pistons located between the distal ends that house rods that are opposing each other; wherein, with internal numerical references (chamber 1) and (chamber 2) of the pneumatic piston, when traversing the rod wall of the piston in one direction, this process requires pressure directed by air hoses that are interconnect with valves to simultaneously fill not only the gas storage chambers (chamber 2), which will discharge pressure out of their gas storage chambers (chamber 1), carry the discharged gas out of the system using air hoses to release the pressure out of the relay exit valve in order to prepare for the respective discharge of pressure out of the originally-filled gas storage chamber (chamber 2) in order to fill the opposing gas storage chamber (chamber 2) so the piston will motion in a reciprocating manner to move and then reset itself to its original position as pressure is input and discharged out the release valve of the relay or control module using either optional pneumatic timing release relay or control module or manual relay controllers with conventional relay or control module.

13. The combined renewable energy and compressed gas energy storage and generation microgrid system of claim 1, where compressed gas energy storage operation is operated by battery 1 or electrical storage unit 1, which interconnects an auxiliary power source or grid and a motorized pump; compressed gas is stored within a gas storage chamber; wherein the system utilizes the generated compressed gas to apply kinetic pressure to a plurality of piezoelectric components, namely relay controllers and a plurality of linear or magnetic induction generators to produce electrical energy; in which the electricity is stored in battery 2, which is referred to as support battery or electrical energy storage unit 2; where battery 1, referred to as operational battery or first electrical energy storage unit storage stores electricity from renewables auxiliary power sources or other source of electric supply; wherein electrical storage unit 1 can be interconnected with electrical energy storage unit 2 to provide extended electrical storage energy to an electric user; in which linear or magnetic induction generators and an auxiliary power source produce electricity that can be (i) transferrable to either first or second electrical energy storage units, depending on energy level demand or requirement, since first electrical energy storage unit can be interconnected to second electrical energy storage unit, or (ii) stored to electrical storage units since the electrical storage units are interconnected.

14. The combined renewable energy and compressed gas energy storage and generation microgrid system of claim 6, where the moisture collected and stored within the compressed gas storage chamber from when the system is using an ambient gas source builds up over time as the high ratio of gas within the volume of the compression chamber heats up during compression, releasing moisture, and likewise cools down during expansion; wherein the water filtration unit, which can consist of a rectangular, bottleneck housing with filtration layers like gravel, sand, charcoal and a cheesecloth or coffee filter to filter water contaminants, can interconnect with an intake/outtake port of the gas storage chamber so moisture can be directed into the water filtration system to supply filtered water that accumulates over time, enabling the system to not only relate to the field of energy production, conservation, and transference but also relate to the field of water collection, conservation, and transference.

15. The combined renewable energy and compressed gas energy storage and generation microgrid system of claim 8, where the linear generators can be aligned in an array—rows and columns—, to trigger each other, where distal end housing comprising of a plural of linear generators can be aligned in an array—columns and rows—at the rear of the prior row of linear generator-based distal end sleeve housing; wherein the rear stem or bar of the prior linear generators are elongated as a result of kinetic force applied to push down the metal bar of the linear generator; wherein the rear stems or bars can rest on a secondary drive bar or magnetic divider that rest on magnets of a secondary row of linear generators so applied kinetic force is transferred from the first row of linear generators to the second row of linear generators and other rows of linear generators following thereafter; wherein a single pneumatic pressure input source will allow an array or series of linear generators to be influenced or triggered to simultaneously produce an electric current discharge or discharged electric current per spring reciprocating cycle.
